(19) United States
(12) Patent Application Publication
(10) Pub. No.: US 2008/0012858 A1
(43) Pub. Date: Jan. 17, 2008

(54) IMAGE PROCESSING METHOD AND COMPUTER READABLE MEDIUM FOR IMAGE PROCESSING

(75) Inventor: Kazuhiko MATSUMOTO, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT, INC., Tokyo (JP)

(21) Appl. No.: 11/753,155

(22) Filed: May 24, 2007

(30) Foreign Application Priority Data
Jul. 11, 2006 (JP) 2006-190298

(51) Int. Cl. G06T 15/50

(52) U.S. Cl. 345/426

(57) ABSTRACT

Shading coefficient β1 is acquired with respect to a gradient vector G of a surface of a polyp and a direction S of a virtual ray (β1=|G·S| [· is inner product]). For example, using a conversion function f using a look-up table (LUT), the shading coefficient β1 is converted into β2 (β2=f (β1), β2<β1). By using the shading coefficient β2 that is lessened in a simulated manner, the polyp is rendered with shading as if it were a polyp with large swelling for enhancing the shading of the edge of the polyp.

This application claims foreign priority based on Japanese Patent application No. 2006-190298, filed Jul. 11, 2006, the content of which is incorporated herein by reference in its entirety.

### BACKGROUND OF THE INVENTION

1. Field of the Invention

This invention relates to an image processing method and a computer readable medium for image processing, for projecting a virtual ray onto an observation object and calculating a virtual reflected light from the observation object so as to generate an image.

2. Description of the Related Art

A technique for visualizing the inside of a three-dimensional object has attracted public attention with the advance of image processing technology using a computer in recent years. Particularly in the medical field, medical diagnosis using a CT (Computed Tomography) apparatus or MRI (Magnetic Resonance Imaging) apparatus has been performed widely because a lesion can be detected early by visualizing the inside of a living body.

On the other hand, volume rendering is known as a method for obtaining a three-dimensional image of the inside of an object. In volume rendering, ray is emitted onto a three-dimensional voxel (micro volume element) space to thereby project an image on a projection plane. Ray casting is a version of volume rendering. In ray casting, image is created from virtual reflected light from voxels along the path of the ray. A voxel value is acquired from voxels at each sampling point which is sampled at a regular interval along the path of the ray.

The voxel is a unit for constituting a three-dimensional region of an object. The voxel value is a specific data expressing characteristic such as a density value of the voxel. The whole object is expressed by voxel data which is a three-dimensional arrangement of the voxel value. Generally, two-dimensional tomogram data obtained by CT is collected along a direction perpendicular to each sectional layer, and voxel data which is the three-dimensional arrangement of voxel value is obtained by performing necessary interpolation.

In ray casting, it is assumed that a virtual reflected light with respect to a virtual ray emitted from a virtual viewpoint to an object is produced according to opacity which is artificially set for the voxel value. To obtain a virtual surface, gradient vector of voxel data, namely, a normal vector is acquired and a shading coefficient for shading is calculated from a cosine of an angle between the virtual ray and the normal vector. The virtual reflected light is calculated by multiplying an intensity of the virtual ray emitted to the voxel, opacity of the voxel and the shading coefficient.

FIG. 8A shows an example of a colon being displayed by a parallel projection method of volume rendering as an example of visualization of a tubular tissue in the inside of a human body. According to such volume rendering, a see-through image of the three-dimensional structure of the colon can be formed from two-dimensional tomogram data obtained successively along a direction perpendicular to sectional layers of the abdomen. The image obtained by the parallel projection method is suitable for observation from the outside but unsuitable for observation from the inside.

FIG. 8B shows an example of achieving an image obtained by a virtual endoscope by generating a centrally (perspective) projected image of the inside of the colon with volume rendering. When voxel data is reconstructed from a viewpoint in the inside of the tubular tissue in this manner, inspection with an endoscope can be simulated. Accordingly, a polyp or the like in the inside of the tubular tissue can be detected. However, the virtual endoscope image has a disadvantage that a large number of images obtained by the virtual endoscope has to be referred to perform diagnosis because the region allowed to be displayed at one time in each image obtained by the virtual endoscope is small.

FIGS. 9A and 9B show an example of display of an exfoliated image of a tubular tissue using a cylindrical coordinate system in ray casting. According to the central projection method as described above, inspection of the colon or the like with an endoscope can be simulated, but it is difficult to understand the position or size of a polyp or the like in the wall of the tubular tissue accurately when the inside of the colon is inspected while scanned.

Therefore, as shown in FIG. 9A, a virtual viewpoint 21 is placed on a central path 23 of a tubular tissue 22 (such as colon). Virtual ray 11 is radiated from the virtual viewpoint 21 in directions perpendicular to the central path 23, and an image of the inner wall surface of the tubular tissue 22 is generated. Then, the image is cut open in parallel to the central path 23 so that an exfoliated image of the inner wall surface of the tubular tissue 22 can be displayed as shown in FIG. 9B.

Thus, in the cylindrical projection method using the cylindrical coordinate system, by assuming that a cylindrical coordinate system is set virtually in the inside of the tubular tissue 22 and performing the projection radially from the central path 23 of the cylindrical coordinate system, a 360° panoramic image of the inner wall surface of the tubular tissue 22 can be generated. Accordingly, a position and a size of a polyp existing in the inner surface of the tubular tissue 22 can be obtained accurately.

FIGS. 10A and 10B are views for explaining a curved cylindrical projection method when a tubular tissue 22 as an observation object is curved. As shown in FIGS. 10A and 10B, the curved cylindrical projection method is a method of projection in which virtual ray 11 is radiated from a curved central path 23 when the tubular tissue 22 as the observation object is curved. As described above, in accordance with the curved cylindrical projection method, by assuming the central path 23 along the real curved internal organ of a human body, and by performing projection with the central path 23 as a center, virtual endoscopy inspection can be performed with CT data. The curved cylindrical projection method is included in the cylindrical projection method.

FIG. 11 is a flowchart in ray casting in a related art. This flowchart indicates a calculation method of each pixel on a screen, and the following calculation is executed for all pixels on an image.

In the ray casting in the related art, first, projection start point O (x, y, z) of a virtual ray and calculation step ΔS (x, y, z) are set (step S51), and initialization is performed as reflected light E=0, remaining light I=1, and current calculation position X (x, y, z)=O (step S52).

Next, an interpolated voxel value V at the position X is calculated from neighbor voxel data of the position X (x, y, z) (step S53), and opacity α corresponding to the interpolated voxel value V is obtained (step S54). Then, color value C corresponding to the interpolated voxel value V is obtained (step S55).

Next, a gradient vector G at the position X is calculated from neighbor voxel data of the position X (x, y, z), and a shading coefficient β is calculated from a ray direction X-0 and G (step S56). The gradient vector is the gradient of the voxel values in the neighbor of the current calculation position, and represents the direction of the surface of the object represented on the volume data. In this example, the gradient vector that is converted into a unit vector is used for the purpose of clarifying that the gradient vector is a direction component; it is not a necessary condition that the gradient vector should be a unit vector. The shading coefficient is a value which represents the virtual shading numerically. Attenuation light D and partial reflected light F at the position X (x, y, z) are calculated as D=I*α and F=β*D*C (step S57). The reflected light E and the remaining light I are updated as I=I−D and E=E+F, and the current calculation position is forwarded as X=X+ΔS (step S58).

Next, whether or not X reaches the end position or whether or not the remaining light I becomes 0 is determined (step S59). If X is not at the end position and the remaining light I is not 0 (no), the process returns to step S53. On the other hand, if X reaches the end position or the remaining light I becomes 0 (yes), the reflected light E is employed as the pixel value of the calculation pixel and the calculation is completed (step S60).

However, in the cylindrical projection method in the related art, virtual rays are projected onto the observation object perpendicularly from the central path of the tubular tissue, and thus the shade of a polyp, etc., with small swelling (bump) is rendered weak and it may be difficult to find a small polyp at an early stage in a medical diagnosis.

FIGS. 12A-12C are drawings to describe a problem of the cylindrical projection method in the related art. FIG. 12A shows a state in which the virtual rays 11 are projected onto the tubular tissue 22 perpendicularly from the central path 23. FIG. 12B shows a polyp E with small swelling and a polyp F with large swelling on the inner surface of the tubular tissue 22. The polyp E with small swelling contains edges 31 and 32 each with a small gradient against the virtual ray and the polyp F with large swelling contains edges 33 and 34 each with a large gradient against the virtual ray. FIG. 12C shows an image of the inner surface of the tubular tissue 22 according to the cylindrical projection method. As shown in FIG. 12C, the polyp F with large swelling is easily found because the shade of the edge is clear, but it is difficult to find the polyp E with small swelling because the shade of the edge is unclear.

One of the purposes of visualizing the inner surface of the tubular tissue 22 according to the cylindrical projection method is to find a polyp on the inner surface of the tubular tissue 22 at an early stage. However, in the cylindrical projection method in the related art, the virtual rays 11 are projected on to the tissue perpendicularly from the central path 23 and thus the polyp E where the shade of the edge is inconspicuous tends to be missed.

On the other hand, hitherto, in the parallel projection method and the central projection method, a sub light source has been provided to irradiate the observation object from the slanting direction thereof so as make conspicuous the irregularities of the observation object. FIG. 13 is a drawing to describe a problem involved when a sub light source is used in a related art. As shown in the figure, to project a virtual ray 11 onto a tubular tissue 22 perpendicularly to create an image, a virtual sub light source 35 is made to irradiate from a direction different from the virtual ray 11 for generating a shade of the observation object so as to make the irregularities conspicuous.

In the method, however, although edges 32 and 34 of polyps E and F on the opposite side to the virtual sub light source 35 are enhanced, the shades of edges 31 and 33 of the polyps E and F to which the virtual sub light source 35 is directly applied become thin and the contours become unclear. Thus, the method is inappropriate for the medical diagnosis intended to find a polyp at an early stage.

### SUMMARY OF THE INVENTION

The present invention has been made in view of the above circumstances, and provides an image processing method and a computer readable medium for image processing capable of generating an image where the shade of the edge of an observation object is enhanced.

In some implementations of the invention, an image processing method using volume data comprises:

projecting a virtual ray onto the volume data;

acquiring at least one parameter associated with shading information from the volume data;

converting the parameter; and

calculating a virtual reflected light based on the converted parameter.

According to the configuration described above, the virtual reflected light can be calculated as if the shading information were large in a simulated manner, so that an image where the shade of the edge of the observation object is enhanced can be generated.

In the image processing method of the invention, the parameter includes at least one of a virtual reflected light, a gradient vector, a shading coefficient, a remaining light amount, and an angle between the gradient and the virtual ray.

In the image processing method of the invention, the parameter is converted so as to enhance the shading information. In the image processing method of the invention, the volume data includes volume data representing an organ.

According to the configuration described above, an image where the shade of the edge of a surface of a tubular tissue such as a large intestine in the inside of a human body is enhanced can be generated.

In the image processing method of the invention, the parameter is converted by using a piecewise continuous function. According to the configuration described above, an image where the shade of the edge is enhanced can be generated by performing simple calculation processing.

The image processing method of the invention further comprising:

rendering the volume data by a cylindrical projection method using the calculated virtual reflected light.

The image processing method of the invention further comprising:

generating an image by rendering the volume data by using the calculated virtual reflected light, by performing network distributed processing.

The image processing method of the invention further comprising:

generating an image by rendering the volume data by using the calculated virtual reflected light, by employing a graphics processing unit (GPU).

In some implementations of the invention, a computer readable medium having a program including instructions for permitting a computer to execute image processing using volume data, the instructions comprising:

projecting a virtual ray onto the volume data;

acquiring at least one parameter associated with shading information from the volume data;

converting the parameter; and

calculating a virtual reflected light based on the converted parameter.

According to the invention, the virtual reflected light can be calculated as if the shading information were large in a simulated manner, so that an image where the shade of the edge of the observation object is enhanced can be generated.

### BRIEF DESCRIPTION OF THE DRAWINGS

In the accompanying drawings:

FIG. 1 is a drawing to schematically show a computed tomography (CT) apparatus used with an image processing method according to an embodiment of the invention;

FIGS. 2A and 2B are drawings to describe shade enhancing;

FIGS. 3A and 3B are drawings to describe example 1 of the image processing method of the invention;

FIG. 4 is a drawing to show an LUT (look-up table) function example in example 1 of the image processing method of the invention;

FIGS. 5A and 5B are drawings to describe example 2 of the image processing method of the invention;

FIG. 6 is a drawing to show an LUT function example in example 2 of the image processing method of the invention;

FIG. 7 is a flowchart of ray casting in the image processing method of an embodiment of the invention;

FIGS. 8A and 8B are drawings to describe visualization of a tubular tissue in the inside of a human body and a virtual endoscope image;

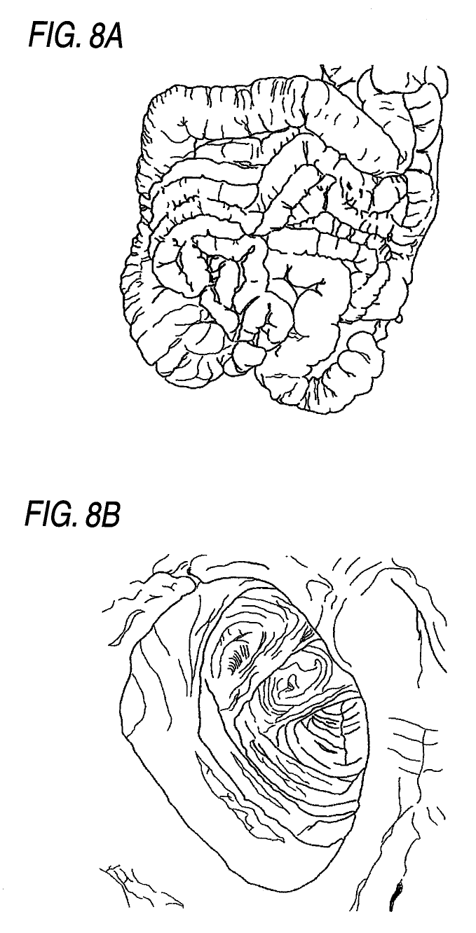

FIGS. 9A and 9B are drawings to show an example of exfoliated display of a tubular tissue using a cylindrical coordinate system;

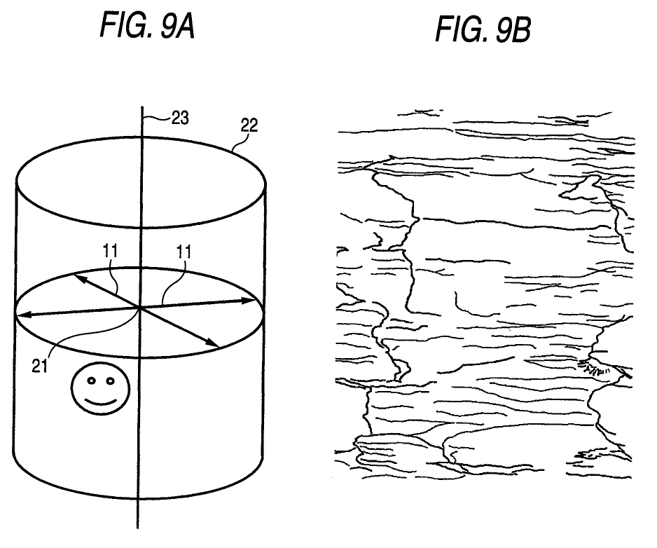

FIGS. 10A and 10B are drawings to describe a curved cylindrical projection method when the tubular tissue of an observation object is curved;

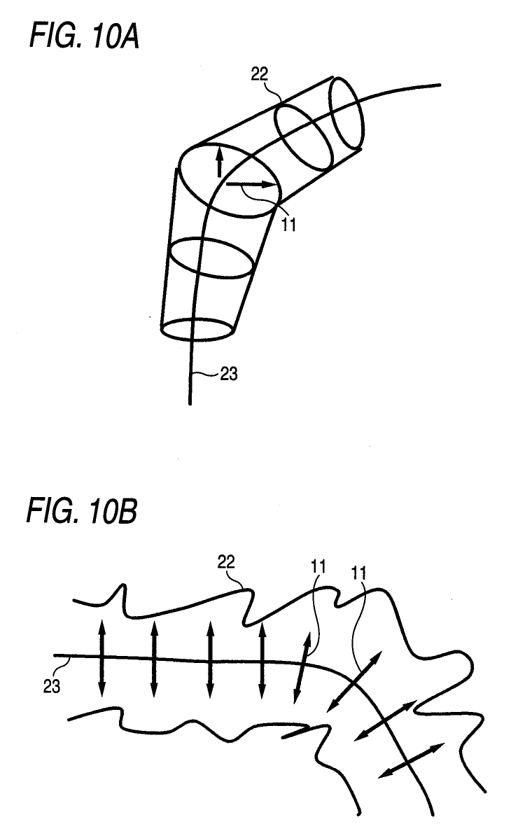

FIG. 11 is a flowchart in ray casting in a related art;

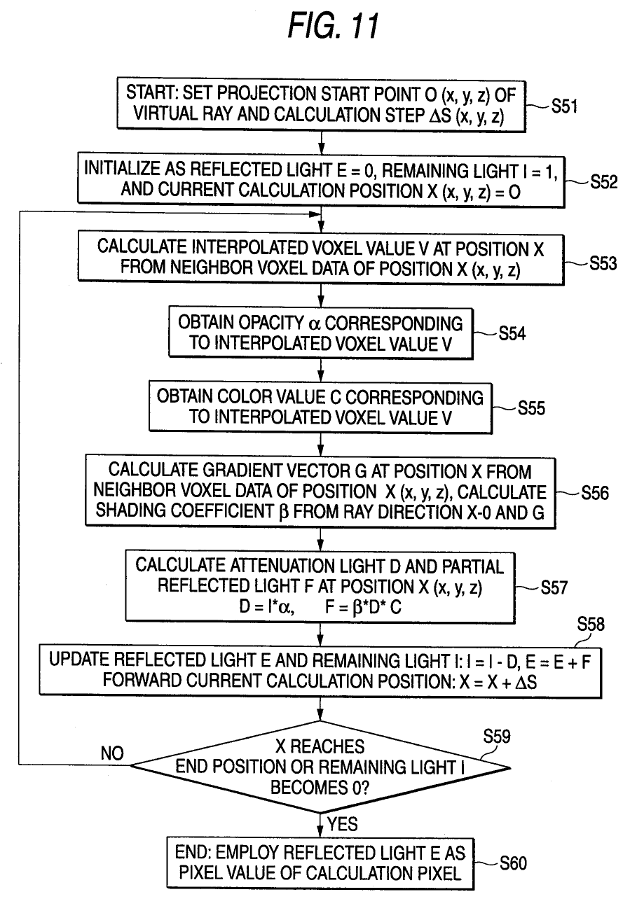

FIGS. 12A-12C are drawings to describe a problem of the curved cylindrical projection method in the related art; and

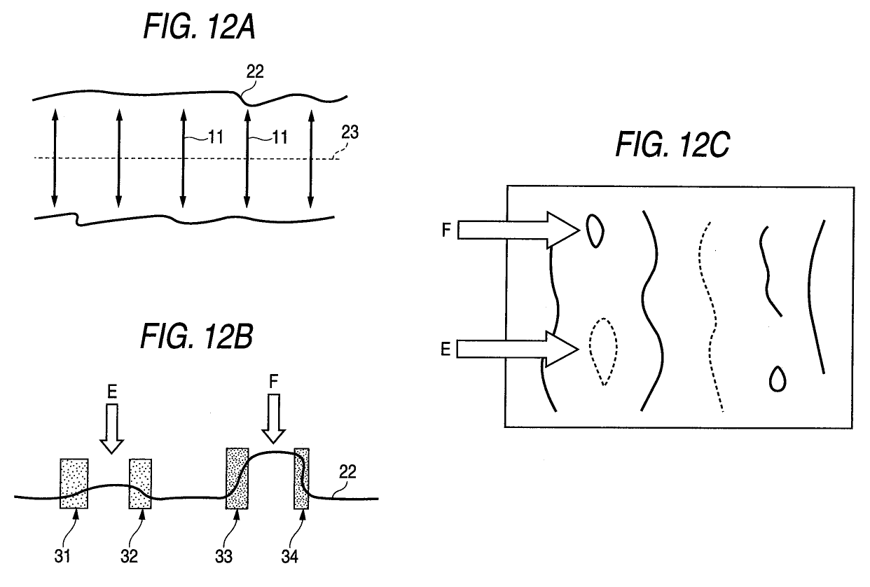

FIG. 13 is a drawing to describe a problem involved when a sub light source is used in a related art.

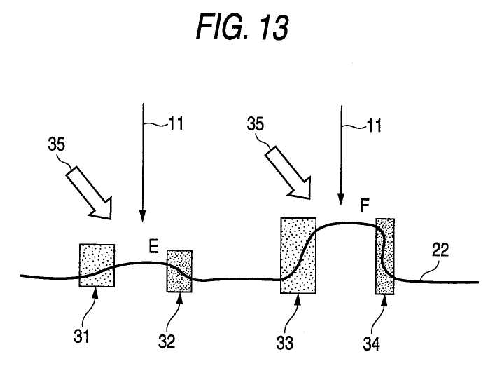

### DESCRIPTION OF THE PREFERRED EMBODIMENTS

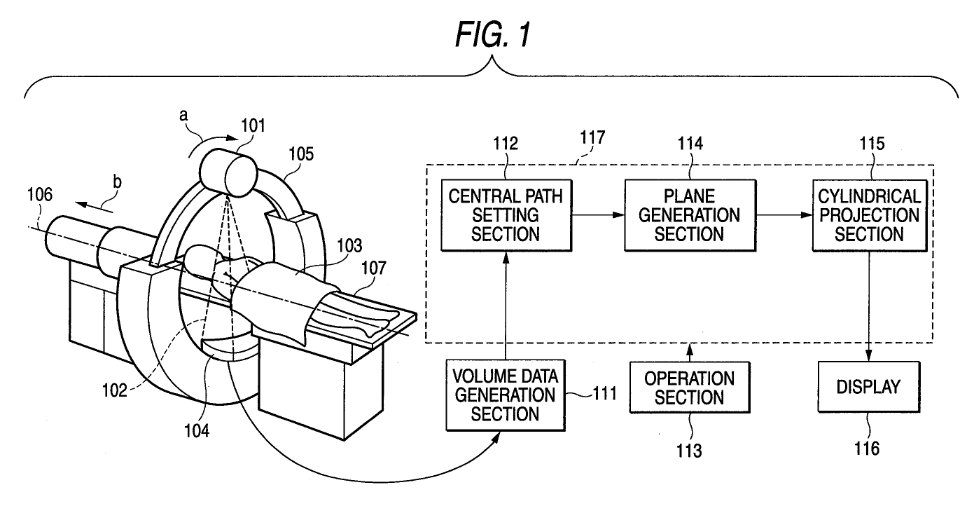

FIG. 1 schematically shows a computed tomography (CT) apparatus used with an image processing method according to one embodiment of the invention. The computed tomography apparatus is used for visualizing tissues, etc., of a subject. A pyramid-like X-ray beam 102 having edge beams which is represented by dotted lines in FIG. 1 is emitted from an X-ray source 101. The X-ray beam 102 is applied on an X-ray detector 104 after transmitting through the subject, for example, a patient 103. In this embodiment, the X-ray source 101 and the X-ray detector 104 are disposed in a ring-like gantry 105 so as to face each other. The ring-like gantry 105 is supported by a retainer not shown in FIG. 1 so as to be rotatable (see the arrow “a”) about a system axis 106 which passes through the center point of the gantry.

In this embodiment, the patient 103 is lying on a table 107 through which the X-rays are transmitted. The table 107 is supported by a retainer which is not shown in FIG. 1 so as to be movable (see the arrow “b”) along the system axis 106.

Thus a CT system is configured so that the X-ray source 101 and the X-ray detector 104 are rotatable about the system axis 106 and movable along the system axis 106 relatively to the patient 103. Accordingly, X-rays can be cast on the patient 103 at various projection angles and in various positions with respect to the system axis 106. An output signal from the X-ray detector 104 when the X-rays are cast on the patient 103 are supplied to a volume data generation section 111 and transformed into a volume data.

In sequence scanning, the patient 103 is scanned in accordance with each sectional layer of the patient 103. When the patient 103 is scanned, while the X-ray source 101 and the X-ray detector 104 rotate around the patient 103 about the system axis 106 as its center, the CT system including the X-ray source 101 and the X-ray detector 104 captures a large number of projections to scan each two-dimensional sectional layer of the patient 103. A tomogram displaying the scanned sectional layer is reconstructed from the measured values acquired at that time. While the sectional layers are scanned continuously, the patient 103 is moved along the system axis 106 every time the scanning of one sectional layer is completed. This process is repeated until all sectional layers of interest are captured.

On the other hand, during spiral scanning, the table 107 moves along the direction of the arrow “b” continuously while the CT system including the X-ray source 101 and the X-ray detector 104 rotates about the system axis 106. That is, the CT system including the X-ray source 101 and the X-ray detector 104 moves on a spiral track continuously and relatively to the patient 103 until the region of interest of the patient 103 is captured completely. In this embodiment, signals of a large number of successive sectional layers in a diagnosing area of the patient 103 are supplied to a volume data generation section 111 by the computed tomography apparatus shown in FIG. 1.

Volume data generated in the volume data generation section 111 is introduced into a central path setting section 112 in an image processing section 117. The central path setting section 112 sets a central path of a tubular tissue contained in the volume data. A plane generation section 114 determines a plane through which a virtual ray used for cylindrical projection passes, by using the set central path and the volume data. The plane generated in the plane generation section 114 is supplied to a cylindrical projection section 115.

The cylindrical projection section 115 performs cylindrical projection of the volume data in accordance with the plane created in the plane generation section 114 to generate a cylindrical projection image. The cylindrical projection image provided by the cylindrical projection section 115 is supplied to and displayed on a display 116. Additionally histograms may be overlaid with cylindrical projection image, and plurality of images may displayed parallel with cylindrical projection image, such as, animation of sequence, simultaneous display with a virtual endoscopic (VE) image.

An operation section 113 contains a GUI (Graphical User Interface) which sets the central path, plane generation, and sets a display angle in spherical cylindrical projection in response to operation signals from a keyboard, a mouse, etc., and generates a control signal of each setup value and supplies the control signal to the central path setting section 112, the plane generation section 114, and the cylindrical projection section 115. Accordingly, a user can interactively change the image and observe the lesion in detail while viewing the image displayed on the display 116.

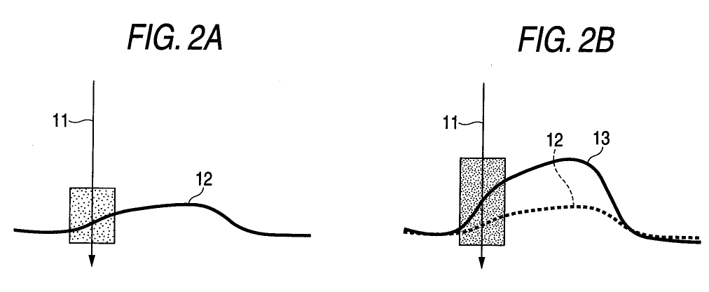

FIGS. 2A and 2B are drawings to describe shade enhancing. As shown in FIG. 2A, in the cylindrical projection method, a virtual ray 11 is projected perpendicularly onto a polyp 12 as an observation object. At this time, in the embodiment of the invention, if swelling of the polyp 12 is small, the polyp 12 is rendered as a polyp 13 with large swelling in a simulated manner as shown in FIG. 2B.

Particularly, in a case the virtual ray 11 is projected onto the polyp 12 as the observation object, virtual reflected light reflected from the polyp 12 is calculated, and the reflected light is used for generating an image. When shading is calculated from a gradient vector on the surface of the polyp 12, a parameter of the polyp 12 is converted and virtual reflected light from the polyp 12 is calculated based on the converted parameter so as to enhance the shading, namely, as if the polyp 12 were the polyp 13 with large swelling in a simulated manner. The conversion amount of the parameter is determined using the gradient vector and a direction vector of the virtual ray.

According to the embodiment of the invention, the virtual reflected light is calculated assuming that an angle between the gradient and the direction vector of the virtual ray is large in a simulated manner, so that an image in which the shading of the edge of the observation object is enhanced can be generated for clearly displaying the contours of the observation object.

### EXAMPLE 1

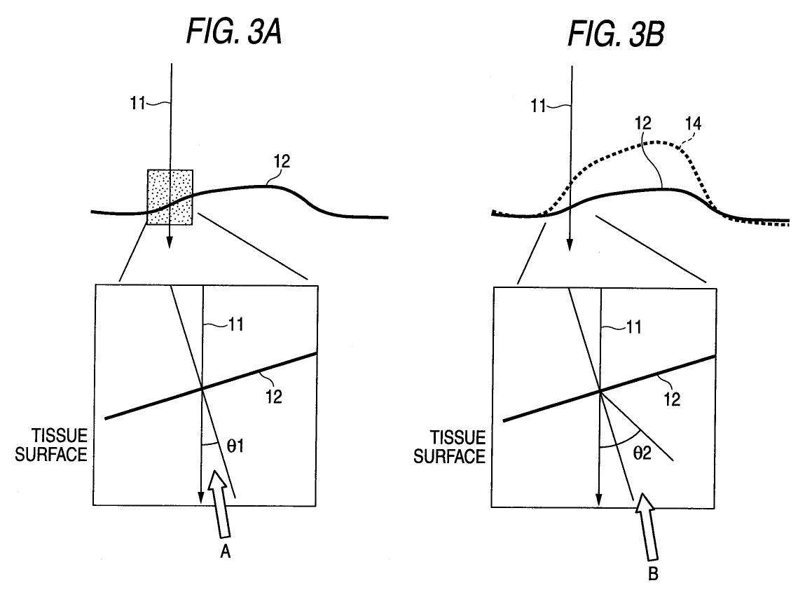

FIGS. 3A and 3B are drawings to describe example 1 of the image processing method of the invention. In the example, the direction of the gradient vector in the voxels forming the surface of the polyp 12 is used to acquire an angle θ1 (arrow A) between the tissue surface of the polyp 12 and the virtual ray 11 as shown in FIG. 3A.

As shown in FIG. 3B, for example, using a conversion function f such as a look-up table (LUT) or a piecewise continuous function, the angle θ1 is converted into an angle θ2 (arrow B: θ2=f (θ1), θ2>θ1), the angle θ2 is made larger than the angle θ1 in a simulated manner, and the polyp 12 is rendered as if it were a polyp 14 with large swelling for enhancing the shading of the polyp.

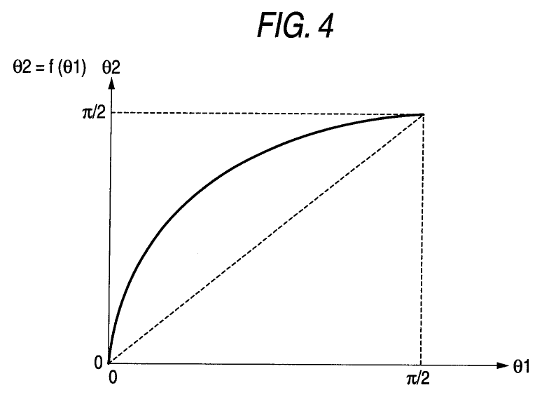

FIG. 4 shows an LUT function example in this example. As shown in the figure, if the angle θ1 at the edge portion is small, the LUT function is used to convert the angle from θ1 into θ2 so that the angle becomes larger in a simulated manner for rendering the polyp. The LUT function can be changed through a GUI for enabling the user to easily change the enhancing degree of the shading of the edge and how to view the edge.

According to the configuration, the parameter dependent on the surface shape of the observation object (the angle between the tissue surface and the virtual ray) is converted according to the piecewise continuous function or the LUT function, whereby the shading of the edge of the observation object can be enhanced by performing simple calculation processing and the contours of the observation object can be displayed clearly. Since the LUT function can be changed through the GUI, a doctor can easily set how to view the observation object in medical diagnosis.

### EXAMPLE 2

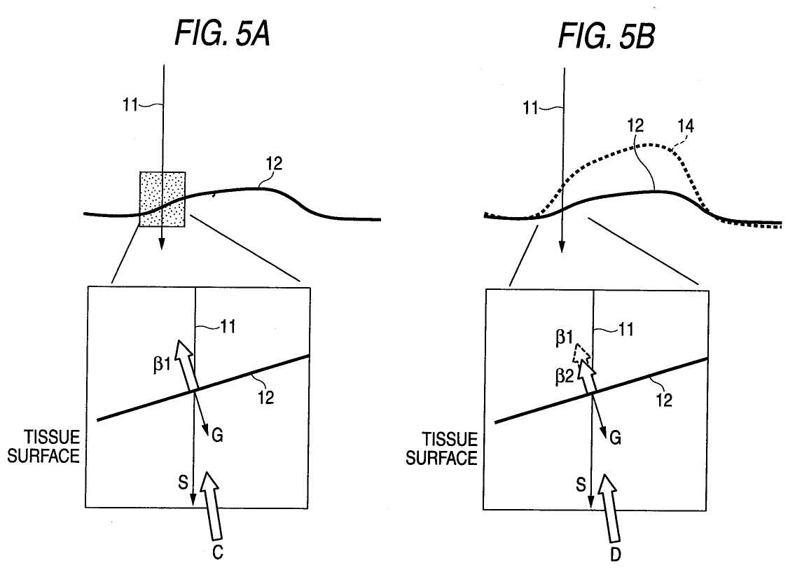

FIGS. 5A and 5B are drawings to describe example 2 of the image processing method of the invention. In the example, the direction of the gradient vector in the voxels forming the surface of the polyp 12 is used to acquire a shading coefficient β1 for representing the shading. Specifically, the shading coefficient β1 is calculated with respect to a gradient vector G of the surface of the polyp 12 and a direction S of the virtual ray 11 (arrow C: β1=|G·S| [· is inner product]) as shown in FIG. 5A.

As shown in FIG. 5B, for example, using a conversion function fusing a look-up table (LUT), the shading coefficient β1 is converted into β2 (arrow D: β2=f (β1), β2<β1). Then, by using the shading coefficient β2 that is lessened in a simulated manner, the polyp 12 is rendered with shading as if it were a polyp 14 with large swelling, for enhancing the edge of the polyp.

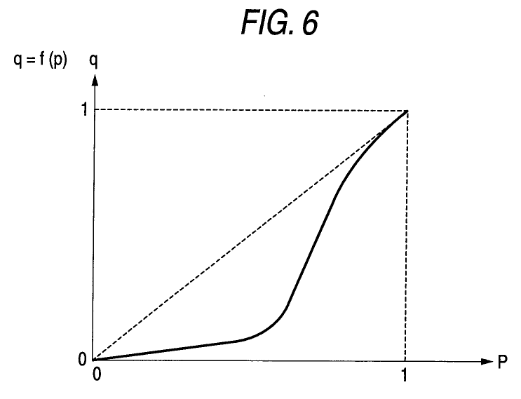

FIG. 6 shows an LUT function example in this example. As shown in the figure, if the shading coefficient p at the edge portion is small, the LUT function is used to lessen the shading coefficient from p to q in a simulated manner for rendering the polyp. The LUT function can be changed through a GUI for enabling the user to easily change the enhancing degree of the shading of the edge and how to view the edge.

According to the configuration, the parameter dependent on the surface shape of the observation object is converted according to the LUT function, whereby the shading of the edge of the observation object can be enhanced by performing simple calculation processing and the contours of the observation object can be displayed clearly. Since the LUT function can be changed through the GUI, a doctor can easily set how to view the observation object in medical diagnosis.

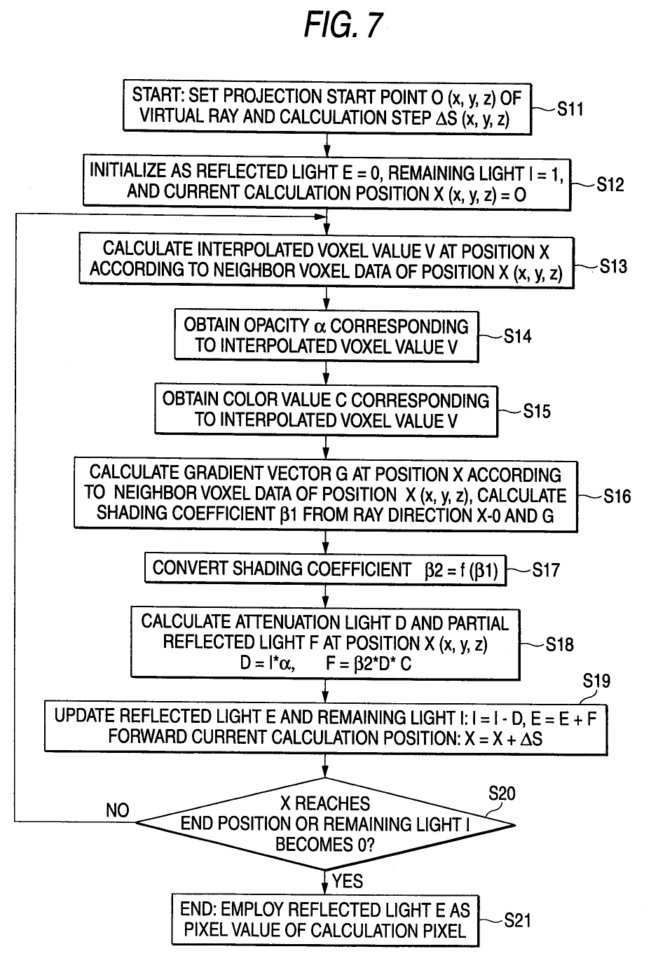

FIG. 7 is a flowchart of ray casting in the image processing method of the embodiment. This flowchart indicates a calculation method of each pixel on an image, and the following calculation is executed for all pixels on the image.

In the image processing method of the embodiment, first, a projection start point O (x, y, z) of a virtual ray and a calculation step ΔS (x, y, z) are set (step S11), and initialization is performed as reflected light E=0, remaining light I=1, and current calculation position X (x, y, z)=O (step S12).

Next, an interpolated voxel value V at the position X is calculated according to neighbor voxels of the position X (x, y, z) (step S13), and opacity α corresponding to the interpolated voxel value V is obtained (step S14). Then, color value C corresponding to the interpolated voxel value V is obtained (step S15).

Next, a gradient vector G at the position X is calculated according to neighbor voxels of the position X (x, y, z), and shading coefficient β1 is calculated from ray direction X-0 and G (step S16). The shading coefficient, which is the parameter having shading information, is converted as β2=f (β1) (step S17).

Next, attenuation light D and partial reflected light F at the position X (x, y, z) are calculated as D =I*α and F=β2*D*C (step S18). The reflected light E and the remaining light I are updated as I=I−D and E=E+F, and the current calculation position is forwarded as X=X+ΔS (step S19).

Next, whether or not X reaches the end position or whether or not the remaining light I becomes 0 is determined (step S20). If X is not at the end position and the remaining light I is not 0 (no), the process returns to step S13. If X reaches the end position or the remaining light I becomes 0 (yes), the reflected light E is employed as the pixel value of the calculation pixel and the calculation is completed (step S21).

Thus, according to the image processing method according to the embodiment, one or more parameters containing or constituting the shading information in the volume data are acquired, the acquired parameter is converted, and virtual reflected light is calculated based on the converted parameter, whereby the virtual reflected light can be calculated as if the shading (shading coefficient) were large in a simulated manner, so that an image in which the shading of the edge of the observation object is enhanced can be generated. Accordingly, when the observation object is an organ in the inside of a human body and particularly when the tubular tissue having a curved portion such as a large intestine is visualized, the edge portions of a polyp, etc., existing on the inner wall surface of the tissue can be enhanced in a simulated manner for clearly displaying the contours of the polyp, etc., so that the presence of a polyp, etc., can be understood clearly.

In the description given above, the angle between the gradient on the surface of the observation object and the virtual ray, and the shading coefficient are respectively used as the parameters converted for enhancing the shading of an edge, but any other parameter may be converted. As the parameter to be converted, any one of the virtual reflected light, the gradient vector, the angle between the gradient and the virtual ray, or the remaining light amount, or a combination thereof may be used.

Calculation process of generating an image can be performed by a GPU (Graphics Processing Unit). GPU is a processing unit designed for being specialized to image processing as compared with a general-purpose CPU, and usually is installed in a computer separately from the CPU.

In the image processing method of the embodiment, volume rendering calculation can be divided at predetermined angle units, image regions, volume regions, etc., and results of the divided processes can be superposed later, so that the volume rendering calculation can be performed by parallel processing, network distributed processing, a dedicated processor, or using them in combination.

The embodiment of the invention can be also achieved by a computer readable medium in which a program code (an executable program, an intermediate code program, and a source program) according to the above described image processing method is stored so that a computer can read it, and by allowing the computer (or a CPU or an MCU) to read out the program (software) stored in the storage medium and to execute it.

The computer readable medium includes, for example, a tape-type medium, such as a magnetic tape or a cassette tape, a disc-type medium including a magnetic disc, such as a floppy (a registered trademark) disc or a hard disc, and an optical disc, such as CD-ROM/MO/MD/DVD/CD-R, a card-type medium, such as an IC card (including a memory card) or an optical card, and a semiconductor memory, such as a mask ROM, an EPROM, an EEPROM, or a flash ROM.

Further, the computer may be constituted such that it can be connected to a communication network, and the program may be supplied thereto through the communication network. The communication network includes, for example, the Internet, the Intranet, an intranet, an extranet, a LAN, an ISDN, a VAN, a CATV communication network, a virtual private network, telephone lines, a mobile communication network, and a satellite communication network. A transmission medium for constituting the communication network includes, for example, wire lines, such as IEEE1394, USB, power lines, cable TV lines, telephone lines, and ADSL lines, infrared rays, such as IrDA or a remote controller, and wireless lines, such as Bluetooth (a registered trademark), 802.11 Wireless, HDR, a mobile communication network, satellite lines, and a terrestrial digital broadcasting network. In addition, the program may be incorporated into carrier waves and then transmitted in the form of computer data signals.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An image processing method using volume data, the image processing method comprising:
projecting a virtual ray onto the volume data;
acquiring at least one parameter associated with shading information from the volume data;
converting the parameter; and
calculating a virtual reflected light based on the converted parameter.

2. The image processing method as claimed in claim 1, wherein the parameter includes at least one of a virtual reflected light, a gradient vector, a shading coefficient, a remaining light amount, and an angle between the gradient and the virtual ray.

3. The image processing method as claimed in claim 1, wherein the parameter is converted so as to enhance the shading information.

4. The image processing method as claimed in claim 1, wherein the volume data includes volume data representing an organ.

5. The image processing method as claimed in claim 1, wherein the parameter is converted by using a piecewise continuous function.

6. The image processing method as claimed in claim 1, further comprising:
rendering the volume data by a cylindrical projection method using the calculated virtual reflected light.

7. The image processing method as claimed in claim 1, further comprising:
generating an image by rendering the volume data by using the calculated virtual reflected light, by performing network distributed processing.

8. The image processing method as claimed in claim 1, further comprising:
generating an image by rendering the volume data by using the calculated virtual reflected light, by employing a graphics processing unit (GPU).

9. A computer readable medium having a program including instructions for permitting a computer to execute image processing using volume data, the instructions comprising:
projecting a virtual ray onto the volume data;
acquiring at least one parameter associated with shading information from the volume data;
converting the parameter; and
calculating a virtual reflected light based on the converted parameter.

10. The computer readable medium as claimed in claim 9, wherein said parameter includes at least one of a virtual reflected light, a gradient vector, a shading coefficient, a remaining light amount, and an angle between the gradient and the virtual ray.

11. The computer readable medium as claimed in claim 9, wherein the parameter is converted so as to enhance the shading information.

12. The computer readable medium as claimed in claim 9, wherein the volume data includes volume data representing an organ.

13. The computer readable medium as claimed in claim 9, wherein the parameter is converted by using a piecewise continuous function.

14. The computer readable medium as claimed in claim 9, the instructions comprising:
rendering the volume data by a cylindrical projection method using the calculated virtual reflected light.

15. The computer readable medium as claimed in claim 9, the instructions comprising:
generating an image by rendering the volume data by using the calculated virtual reflected light, by performing network distributed processing.

16. The computer readable medium as claimed in claim 9, the instructions comprising:
generating an image by rendering the volume data by using the calculated virtual reflected light, by employing a graphics processing unit (GPU).
